(19) United States
(12) Patent Application Publication
(10) Pub. No.: US 2010/0024578 A1
(43) Pub. Date: Feb. 4, 2010

(54) VIBRATOR WITH A VARIABLE MOMENT USING A PHASE SHIFTER WITH REDUCED CLEARANCES

(75) Inventor: Mathieu Jehanno, Paris (FR)

Correspondence Address: YOUNG & THOMPSON, 209 Madison Street, Suite 500, Alexandria, VA, 22314, US

(73) Assignee: P T C, Pantin (FR)

(21) Appl. No.: 12/506,399

(22) Filed: Jul. 21, 2009

(30) Foreign Application Priority Data
Jul. 30, 2008 (FR) 08 04336

(51) Int. Cl. F16H 33/08

(52) U.S. Cl. 74/61

(57) ABSTRACT

A vibrator with a variable moment uses a phase shifter (7) including at least two trains of flyweights each including at least two eccentric flyweights driven into rotation by two cogs which mesh with each other so as to rotate in the opposite direction relative to each other. Both trains of flyweights are coupled to each other through a remotely controllable phase shifter (7) including a first tubular drive shaft (9) interdependent in rotation at one of the its ends, with a first cog (P4) and a second central drive shaft (6) which engages into the first tubular drive shaft (9) and which is interdependent in rotation with a second cog (P3) located opposite to the first cog (P4). A tubular transmission part (8) interdependent in rotation with the first tubular drive shaft (9) ensures a diversion of the stresses exerted at the cogs (P3, P4) thereby relieving the phase shifter.

### BACKGROUND OF THE INVENTION

1. Field of the Invention

The object of the present invention is a vibrator with a variable moment using a phase shifter with reduced clearances.

It relates to a vibrator with a variable moment which may notably, but not exclusively, be used for driving into the ground, objects such as stakes or pile-planks, and featuring reduced clearances.

2. Description of the Prior Art

Generally, it is known that the vibrators currently used in this kind of application involve at least a pair of flyweights off-centered relatively to their drive axis and means for driving into rotation both drive axes at a same speed but in an opposite direction.

It is clear that by these arrangements, the centrifugal forces generated by the rotation of the flyweights are added in a direction defining a working axis and are compensated in the other directions so as to cancel out in a direction perpendicular to the working axis.

It is found that for multiple reasons, it is desirable to carry out an adjustment of the amplitude of the vibrations generated by the vibrator, for example:
in order to take into account the mechanical characteristics of the ground,
in order to limit the amplitude of the vibrations close to buildings, and
in order to suppress the parasitic vibrations generated upon starting and stopping the vibrator.

In order to reach this result, the vibrators involve at least two trains of eccentric flyweights each comprising at least two eccentric flyweights rotatably mounted around shafts interdependent with two respective cogs which mesh with each other so as to rotate in an opposite direction relatively to each other, a motorization comprising at least a first motor directly or indirectly coupled to the first train of flyweights and a phase shifter engaged with both trains of flyweights.

In order to carry out this phase shifter, many solutions have been proposed; the solution using a helicoidal device subsequently called a rotary actuator, is the subject of a French patent filed by the Applicant under No. 91 09253.

This rotary actuator notably comprises:
a first transmission shaft rotatably mounted on a fixed structure, this shaft comprising at least one portion appearing as a cylindrical sleeve, the inner bore of which comprises a first sealing surface followed by a first threaded portion;
a second transmission shaft of cylindrical shape, which engages into the cylindrical sleeve of the first transmission shaft by delimiting with the latter an annular space, closed on one side by a bottom, this second transmission shaft successively comprising a second sealing surface and second threaded portion;
an annular part acting as an axially mobile piston in said annular space and having an cylindrical outer face successively comprising a third sealing surface capable of sealably sliding on the aforesaid first sealing surface and a third threaded portion having helicoidal ramps sliding in the helicoidal ramps of the aforesaid first threaded portion, and an inner face successively comprising a fourth sealing surface capable of sealably sliding on the aforesaid second sealing surface and a fourth threaded portion having helicoidal ramps sliding in the helicoidal ramps of the aforesaid second threaded portion;
a circuit for admitting a pressurized fluid allowing axial displacement of the aforesaid piston under the effect of this fluid in two working chambers, delimited by the aforesaid transmission shaft and the aforesaid piston, via rotating gaskets.

Although this solution is satisfactory, it has a number of drawbacks.

Indeed, as the vibratory context is very demanding for mechanical parts, experience has shown that moving parts are subject to significant wear; the latter therefore have frequent maintenance and thus burden the operating costs in terms of replacement of parts and immobilization of the equipment.

The structure of the vibrator, as described earlier, is not optimized in terms of maintenance taking into account the reduced accessibility to the phase shifter and to the moving parts, the latter for the most part, being particularly bulky and heavy.

Moreover, it is found that the stresses exerted at the cogs for driving the shafts comprising eccentric flyweight trains, are for the most part transmitted to the phase shifter; which is structurally fragile taking into account the moving parts hydraulically sealed and therefore particularly toleranced.

### OBJECT OF THE INVENTION

More particularly, the object of the invention is to suppress these drawbacks.

### SUMMARY OF THE INVENTION

For this purpose, it proposes a vibrator with a variable moment, comprising at least two trains of flyweights each comprising at least two eccentric flyweights driven into rotation by two cogs which mesh with each other so as to rotate in the opposite direction relatively to each other, at least one of said trains being driven by a motor, both trains being coupled to each other through a remotely controllable phase shifter, this phase shifter comprising two coaxial drive shafts provided with two respective cogs engaged with two cogs respectively interdependent in rotation with two trains of flyweights, both of these coaxial shafts being coupled to each other through connection means being able to provide synchronous transmission of the movement of rotation of one of the two drive shafts, these connection means further comprising controllable means for driving into rotation one of the two drive shafts relatively to the other in order to generate a controllable phase shift between both drive shafts.

According to the invention, this vibrator is characterized in that it further comprises a tubular transmission part, interdependent in rotation with the first tubular drive shaft, so that said tubular transmission part ensures diversion of the stresses exerted by the vibrator at the cogs thereby relieving the phase shifter.

According to a first embodiment of the invention, the aforesaid connection means may involve:
a first transmission shaft rotatably mounted on a fixed structure, this shaft comprising at least one portion appearing as a cylindrical sleeve, the inner bore of which comprises a first sealing surface followed by a first threaded portion;
a second transmission shaft of cylindrical shape, which engages into the cylindrical sleeve of the first transmission shaft by delimiting with the latter an annular space, closed on one side by a bottom, this second transmission shaft successively comprising a second sealing surface and a second threaded portion;
an annular part acting a an axially mobile piston in said annular space, and having a cylindrical outer face successively comprising a third sealing surface capable of sealably sliding on the aforesaid first sealing surface and a third threaded portion having helicoidal ramps sliding in the helicoidal ramps of the aforesaid first threaded portion, and an inner face successively comprising a fourth sealing surface capable of sealably sliding on a the aforesaid second sealing surface and a fourth threaded portion having helicoidal ramps sliding in the helicoidal ramps of the aforesaid second threaded portion;
a circuit for admitting pressurized fluid allowing axial displacement of the aforesaid piston under the effect of this fluid in two working chambers, delimited by the aforesaid transmission shafts and the aforesaid piston, via rotating gaskets.

Advantageously, the pressurized fluid admission circuit may be designed so as to allow servo-control of the phase shift and therefore of the vibratory power transmitted by the vibrator.

Of course, the invention is not limited to this type of connection means; these connection means may indeed comprise a rotary hydraulic actuator, for example of the vane type, or even an electric actuator.

Moreover, the aforesaid drive shaft may be rotatably mounted in a bearing formed in a first sidewall of the casing of the vibrator; also, the aforesaid second drive shaft may be rotatably mounted in a bearing formed in a second sidewall of the casing of the vibrator.

Advantageously, the bearing formed in said first sidewall of the casing of the vibrator may comprise a rolling bearing with axial stops positioned between this first wall and a first end of the tubular transmission part bearing the first cog and into which engages a cylindrical portion coaxially extending the first tubular drive shaft.

Therefore, transmission of the forces related to the operation of the vibrator is obtained from the first sidewall to the tubular transmission part.

The bearing formed in said second sidewall of the casing may, as for it, comprise a rolling bearing with axial stops positioned between said second wall and said cog interdependent with the second drive shaft and which makes with the first tubular drive shaft, an annular passage into which engages the second end of the tubular transmission part.

With this assembly, it is possible to ensure transmission of the forces related to the operation of the vibrator between both sidewalls and the tubular transmission part, thereby relieving the phase shifter.

Advantageously, a sliding ring is mounted interdependently with the tubular transmission part in the vicinity of the second cog, and positioned in the annular passage, this sliding ring allowing the second cog to be rotatably mounted around said tubular transmission part.

### BRIEF DESCRIPTION OF THE DRAWINGS

Embodiments of the method according to the invention will be described hereafter, as non-limiting examples, with reference to the appended drawings wherein:

FIGS. 1 and 2 are two schematic sectional views, axial and transverse sections respectively, of a vibrator with a variable moment;

FIG. 3 is a schematic axial sectional view of a first version of a phase shifter according to the invention, used in the vibrator illustrated in FIGS. 1 and 2;

FIG. 4 is a schematic axial sectional view of a second version of a phase shifter according to the invention, used in the vibrator illustrated in FIGS. 1 and 2.

### DESCRIPTION OF THE PREFERRED EMBODIMENTS

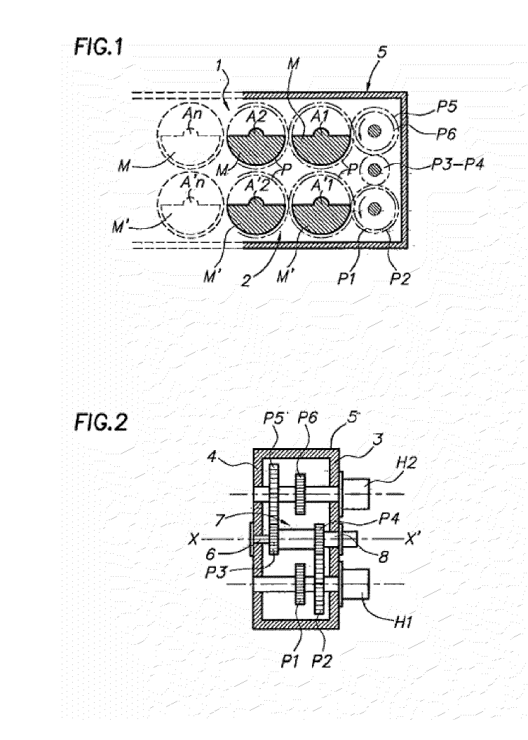

In the example illustrated in FIGS. 1 and 2 the vibrator comprises two trains 1 and 2 of off-centered flyweights rotatably mounted by means of shafts A1, A2, An-A′1, A′2, A′n, parallel to a transverse axis X, X′, and the ends of which engage into bearings borne by two parallel walls 3, 4, forming both lateral sides of a casing 5.

With each of the flyweights M, M′ is associated a cog P positioned and dimensioned so that the cogs P associated with a same train 1, 2, of flyweights M mesh with each other, by successive pairs thereof.

In FIG. 1, two trains of flyweights M are illustrated, each comprising a pair of flyweight/cog P assemblies illustrated in solid lines, the assembly partly illustrated in dashed lines indicating the implantation mode of another pair.

The driving into rotation of both trains of flyweights is ensured by means of motorization, for example comprising two hydraulic motors H1, H2, mounted on the wall 3 at one of the ends of the casing 5.

According to FIG. 2, both of these motors H1, H2, drive two parallel respective shafts through bearings interdependent with the walls 3, 4, and which each bear two coaxial cogs P1, P2-P5, P6, respectively.

Cog P1, interdependent with the shaft of the motor H1, will mesh with the cog P interdependent with its flyweight M′ in order to perform the driving into rotation of the train 2.

Cog P6, interdependent with the shaft of the motor H2, will mesh with the cog P interdependent with its flyweight M in order to perform the driving into rotation of the train 1.

In order to generate a change in amplitude of the vibratory movement, the vibrator further comprises a phase shifter advantageously, but not exclusively, with a hydraulic control according to the invention, essentially comprising:
a driving shaft bearing a cog P3 meshing with the cog P5 interdependent with the output shaft of the motor H2, and
a driven shaft bearing a cog P4 meshing with a cog P2 interdependent with the output shaft of the motor H1.

Of course, the cog P3 may for example mesh with any of the cogs P associated with the flyweights M of the train 1; while the cog P4 may mesh with any of the cogs P associated with the flyweights M′ of the train 2.

It clearly appears that all the shafts of this structure are parallel and mounted on bearings interdependent with both walls 3, 4, and that the shafts directly driven by the motors H1, H2, as well as both coaxial shafts 6, 8 of the phase shifter 16, are distinct from the shafts on which are mounted the flyweights M, M′.

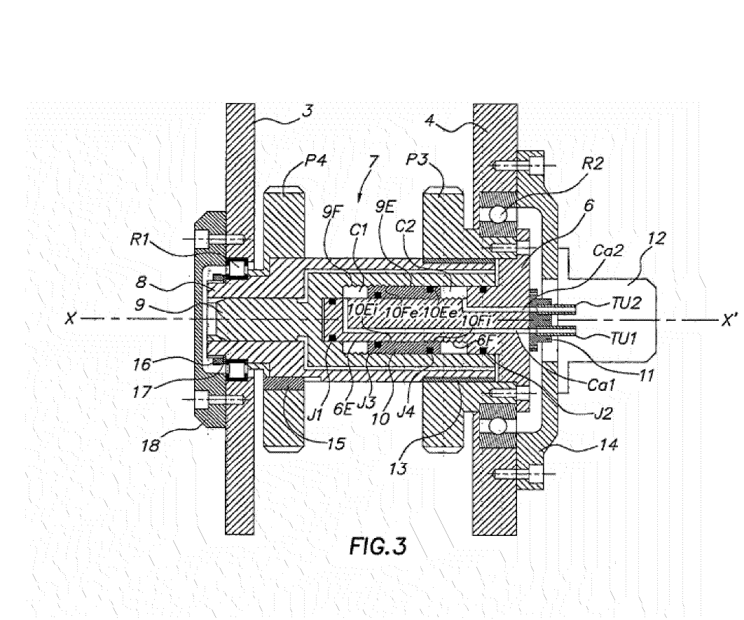

As illustrated in FIG. 3, the phase shifter 7 according to the invention consists of a cylindrical structure interdependent with the walls 3 and 4.

This cylindrical structure 7 comprises:
a first tubular drive shaft 9 (driven shaft), rotatably mounted on the wall 3 via a rolling bearing with axial stops R1, this shaft 9 interdependent in rotation with a first cog P4, comprising a cylindrical portion, and at least one portion appearing as a cylindrical sleeve, comprising a first threaded portion 9F followed by a first sealing surface 9E,
a second central drive shaft 6 (driving shaft) of a cylindrical shape, rotatably mounted on the wall 4 via a rolling bearing with axial stops R2, coaxially with the first tubular drive shaft 9, interdependent in rotation with a second cog P3,
a tubular transmission part 8, comprising a hollow cylindrical portion slidably mounted on the cylindrical portion of the first drive shaft 9 in the vicinity of the first cog P4, and interdependent in rotation with the latter by coupling with keys or flutings for example.

The second central drive shaft 6 (driving shaft), of cylindrical shape, delimits with the aforesaid first tubular drive shaft 9, an annular space, closed on one side by a bottom, this second central drive shaft 6 successively comprising a second sealing surface 6E followed by a second threaded portion 6F.

An annular part 10 acting as an axially mobile piston in said annular space and having a cylindrical external face successively comprising a third sealing surface 10Ee capable of sealably sliding on the aforesaid first sealing surface 9E and a third threaded portion 10Fe having helicoidal ramps sliding in the helicoidal ramps of the aforesaid first threaded portion 9F, and a cylindrical inner face successively comprising a fourth sealing surface 10Ei capable of sealably sliding on the aforesaid second sealing surface 6E and a fourth threaded portion 10Fi having helicoidal ramps sliding in the helicoidal ramps of the aforesaid second threaded portion 6F.

The space comprised between the aforesaid annular part 10 and the bottom of the aforesaid first tubular drive shaft 9, forms a first working chamber C1 (main working chamber) into which a hydraulic fluid may be admitted by means of a conduit Ca1 made in the second central drive shaft 6.

Also, the space comprised between the aforesaid annular part 10 and the aforesaid shoulder of the second central drive shaft 6, forms a second working chamber C2 (secondary working chamber) into which a hydraulic fluid may be admitted by means of a conduit Ca2 made in the second central drive shaft 6.

The seal of the aforesaid working chamber C1 is ensured:
by a gasket J1 between the first tubular drive shaft 9 and the second central drive shaft 6 on the one hand,
by a gasket J3 between the annular part 10, in the vicinity of the sealing surface 10Ei, and the second central drive shaft 6, in the vicinity of the sealing surface 6E on the other hand.

The seal of the aforesaid working chamber C2 is ensured:
by a gasket J2 between the first tubular drive shaft 9 and the second central drive shaft 6 on the one hand,
by a gasket J4 between the annular part 10, in the vicinity of the sealing surface 10Ee, and the first tubular drive shaft 9, in the vicinity of the sealing surface 9E on the other hand.

The aforesaid conduits Ca1, Ca2, are respectively fed through the connection tubes Tu1, Tu2, and an adapter 11 interdependent with the external surface of the second central drive shaft 6; both of these connection tubes Tu1, Tu2 are then associated with a rotating gasket 12 allowing fluid to supplied from a fixed hydraulic network not shown.

When the pressurized fluid is injected into the working chamber C1, this piston 10 is subject to an axial force which tends to move it opposite to the bottom of the first tubular drive shaft 9 and so to generate a double relative rotation between both drive shafts 6 and 9, and this, by the joint action of the helicoidal ramps 9F and 10Fe on the one hand and of the helicoidal ramps 6F and 10Fi on the other hand. Of course, the latter are designed so as to cause a double relative rotation of the drive shafts 6 and 9, for producing the phasing of the flyweights.

When the fluid is injected into the working chamber C2, the piston is subject to a displacement towards the bottom of the first tubular drive shaft 9, and generates a double relative rotation in the opposite direction of both drive shafts 6 and 9.

It is clear that this relative rotation only occurs insofar that the increment of the driving torque resulting from the admission of the pressurized fluid into the chamber C1, becomes larger than the resistant torque which the object subject to vibrations opposes to the vibrator (resistance to sinking).

The aforesaid cog P3 interdependent with the shoulder of the second central drive shaft 6, comprises a bore which surrounds the cylindrical outer portion of the tubular transmission part 8; the rotary contact between the bore of the cog P3 and the cylindrical outer portion of the tubular transmission part 8 is ensured by a sliding ring 13 interdependent with the tubular transmission part 8.

The aforesaid rolling bearing R2 is thereby maintained:
in the vicinity of its internal ring, by the cog P3 on the one hand and by the shoulder of the second drive shaft 6 on the other hand, and
in the vicinity of its external ring, by the wall 4 on the one hand and by an external flange 14, interdependent with the wall 4 on the other hand.

The rolling bearing R2 will for example be a ball bearing with a large diameter, close to that of the cog P3, so as to allow absorption of high axial and radial forces related to the operation of the vibrator with a variable moment, while allowing reduced axial clearance.

The aforesaid cog P4 is interdependent with the tubular transmission part 8 via a key 15.

Said rolling bearing R1 is thereby maintained:
in the vicinity of its internal ring, by the cog P4 on the one hand and by a nut with notches 16 and its ring with notches 17 on the other hand, and
in the vicinity of its external ring, by the wall 3 on the one hand and by an external flange 18, interdependent with the wall 3 on the other hand.

The rolling bearing R1 will for example be a roller bearing of the NUP type, so as to allow absorption of high radial forces related to the operation of the vibrator with a variable moment, while allowing axial tightness clearance.

As this was described earlier, the first tubular drive shaft 9 comprises a solid cylindrical portion slidably mounted in the aforesaid hollow cylindrical portion of the tubular transmission part 8 and interdependent in rotation with the latter by a coupling with flutings; this radial coupling allows a certain relative displacement between the first tubular drive shaft 9 and the tubular transmission part 8, and thus allows some axial clearance between the portions facing the first tubular drive shaft 9 with those of the tubular transmission part 8 and of the second central drive shaft 6; on the other hand, the aforesaid hollow cylindrical portion of the first tubular drive shaft 9, the internal bore of which comprises a first threaded portion 9F followed by a first sealing surface 9E, has a smaller external diameter than the internal diameter of the aforesaid portion appearing as a cylindrical sleeve, of the tubular transmission part 8; thus, the radial clearance between the first tubular drive shaft 9 and the tubular transmission part 8 and the axial plays between the first tubular drive shaft 9 and the tubular transmission part 8 on the one hand and the first tubular drive shaft 9 and the second central drive shaft 6 on the other hand, allow suppression of the transmission of the stresses to which are subject the aforesaid cogs P3, P4, to the piston 10, in the vicinity of the sealing surfaces 6E, 9E, 10Ei, 10Ee and the helicoidal ramps 6F, 9F, 10Fi, 10Fe.

Also, the different clearances mentioned earlier allow suppression of the vibrations generated by the vibrator with a variable moment, to the same piston 10.

Moreover, the structure of the phase shifter according to the invention, as described earlier, is optimized in terms of maintenance; indeed, disassembly of the aforesaid external flange 14 allows access to the assembly consisting of the aforesaid second central drive shaft 6 and of the aforesaid first tubular drive shaft 9, which are associated by the aforesaid piston 10; this assembly, forming the actually hydraulic portion of the phase shifter of a vibrator with variable moment, may thereby be detached from the vibrator without disassembling the aforesaid cogs P3, P4 and the aforesaid rolling bearings R1, R2.

This assembly, consisting of the first tubular drive shaft 9, of the second central drive shaft 6 and of the piston 10, may in turn be easily disassembled so as to allow inspection of the sealing surfaces, of the helicoidal ramps as well as of the seal gaskets.

Of course, the first cog P4 may be interdependent in rotation with the second central drive shaft 6, and the second cog P3 may be interdependent in rotation with the first tubular drive shaft 9.

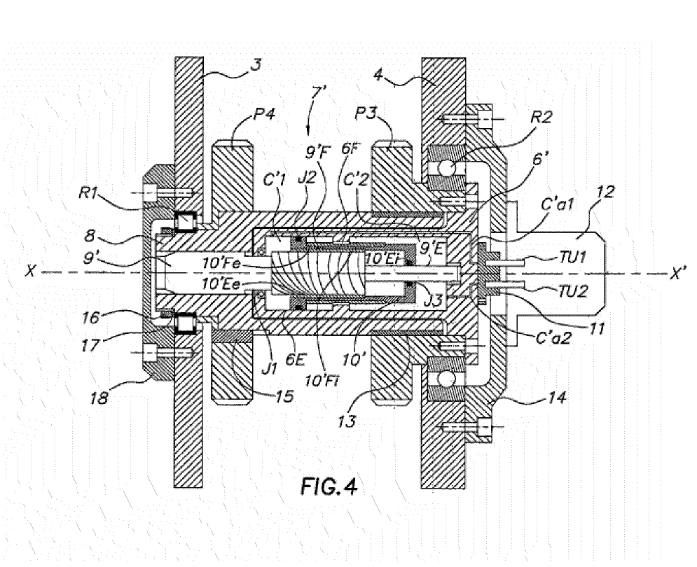

As illustrated in FIG. 4, the phase shifter 7′, according to the invention, consists of a cylindrical structure interdependent with the walls 3 and 4 of the casing of the vibrator.

This cylindrical structure 7′ comprises:
a first cylindrical drive shaft 9′ (driven shaft), rotatably mounted on the wall 3 via a rolling bearing with axial stops R1, this shaft 9′, interdependent in rotation with a first cog P4, comprising a cylindrical portion, and at least one portion appearing as a cylindrical sleeve, comprising a first threaded portion 9′F followed by a second sealing surface 9′E,
a second central drive shaft 6′ (driving shaft) of tubular shape, rotatably mounted on the wall 4 via a rolling bearing with axial stops R2, coaxially with the first cylindrical drive shaft 9′ interdependent in rotation with a second cog P3,
a cylindrical transmission part 8, comprising a hollow cylindrical portion slidably mounted around the cylindrical portion of the first cylindrical drive shaft 9′ in the vicinity of the first cog P4, and interdependent in rotation with the latter by coupling with keys or splines.

The second tubular drive shaft 6′ (driving shaft) delimits with the aforesaid first cylindrical drive shaft 9′, an annular space, closed on one side by a bottom, this second tubular drive shaft 6′ comprising a bore successively comprising a second sealing surface 6′E followed by a second threaded portion 6′F.

An annular part 10′ acting as an axially mobile piston in said annular space and having a cylindrical outer face successively comprising a third sealing surface 10′Ee capable of sealably sliding on the aforesaid first sealing surface 9′E and a third threaded portion 10′Fe having helicoidal ramps sliding in the helicoidal ramps of the aforesaid first threaded portion 9′F, and an inner face successively comprising a fourth sealing surface 10′Ei capable of sealably sliding on the aforesaid second sealing surface 6′E and a fourth threaded portion 10′Fi having helicoidal ramps sliding in the helicoidal ramps of the aforesaid second threaded portion 6′F.

The space comprised between the aforesaid annular part 10′ and the bottom of the aforesaid second tubular drive shaft 6′, forms a first working chamber C′1 (main working chamber) into which a hydraulic fluid may be admitted by means of a conduit C′a1 made in the second tubular drive shaft 6′.

Likewise, the space comprised between the aforesaid annular part 10′ and the aforesaid shoulder of the second tubular drive shaft 6′, forms a second working chamber C′2 (secondary working chamber) into which a hydraulic fluid may be admitted by means of a conduit C′a2 made in the second tubular drive shaft 6′.

The seal of the aforesaid working chamber C′1 is ensured:
by a gasket J1 between the first cylindrical drive shaft 9′ and the second tubular drive shaft 6′, on the one hand,
by a gasket J2 between the annular part 10′, in the vicinity of the sealing surface 10′Ee, and the second tubular drive shaft 6′, in the vicinity of the sealing surface 6′E, on the other hand.

The seal of the aforesaid working chamber C′2 is insured:
by a gasket J3 between the first cylindrical drive shaft 9′ and the annular part 10′, on the one hand,
by the gasket J2 between the annular part 10′, in the vicinity of the sealing surface 10′Ee, and the second tubular drive shaft 6′, in the vicinity of the sealing surface 6′E, on the other hand.

The aforesaid conduits C′a1, C′a2, are respectively fed through the connection tubes Tu1, Tu2, and an adapter 11, interdependent with the external surface of the second tubular drive shaft 6′; both of these connection tubes Tu1, Tu2, are then associated with a rotating gasket 12 allowing fluid to be supplied from a fixed hydraulic network not shown.

As this was described earlier, the first cylindrical drive shaft 9′ comprises a cylindrical portion slidably mounted in the aforesaid hollow cylindrical portion of the tubular transmission part 8 and interdependent in rotation with the latter by coupling with a key or with flutings; this radial coupling allows a certain relative displacement between the first cylindrical drive shaft 9′ and the tubular transmission part 8, and thus allows a certain axial clearance between the portions facing the first cylindrical drive shaft 9′ with those of the second tubular drive shaft 6′ and the tubular transmission part 8; on the other hand, the radial clearance between the bore of the tubular transmission part 8 and the second tubular drive shaft 6′ and the axial clearances between the tubular transmission part 8 and the second drive shaft 6′ allow suppression of the transmission of these stresses to which are subject the aforesaid cogs P3, P4, to the piston 10′, in the vicinity of the sealing surfaces 6′E, 9′E, 10′Ei, 10′Ee, and the helicoidal ramps 6′F, 9′F, 10′Fi, 10′Fe.

Also, the different clearances mentioned earlier, allow suppression of the vibrations generated by the vibrator with variable moment, to the same piston 10′.

1. A vibrator with a variable moment, integrated in a casing, using a phase shifter with reduced clearances, comprising at least two trains of flyweights each comprising at least two eccentric flyweights driven into rotation by two cogs which mesh with each other so as to rotate in an opposite direction relatively to each other, at least one of said trains of flyweights, being driven by a motor the two trains of flyweights being coupled to each other by a remotely controllable phase shifter, this phase shifter comprising two coaxial drive shafts, provided with two respective cogs, engaged with two cogs respectively interdependent with two trains of flyweights, both of these coaxial drive shafts, being coupled with each other through connection means able to ensure synchronous transmission of the movement of rotation of one of the two coaxial drive shafts, to the other drive shaft, these connection means further comprising controllable means for driving into rotation one of the coaxial drive shafts, relatively to the other in order to generate a controllable phase lag between the coaxial drive shafts,
wherein said vibrator further comprises a tubular transmission part, interdependent in rotation with the first drive shaft, so that said tubular transmission part ensures a diversion of the stresses exerted at the cogs.

2. The vibrator according to claim 1,
wherein the first drive shaft is rotatably mounted in a bearing formed in a first sidewall of the casing of the vibrator, this bearing comprising a rolling bearing positioned between said first wall and a first end of the tubular transmission part bearing one of said cogs (the first) and into which engages a cylindrical portion coaxially extending the first drive shaft.

3. The vibrator according to claim 2,
wherein the second drive shaft is rotatably mounted in a bearing formed in a second sidewall of the casing of the vibrator, this bearing comprising a rolling bearing positioned between said second wall and the second cog interdependent with the second drive shaft, this second cog making with the first drive shaft an annular passage into which engages the second end of the tubular transmission part.

4. The vibrator according to claim 3,
comprising a sliding ring mounted interdependently with the tubular transmission part and positioned in the aforesaid annular passage.

5. The vibrator according to claim 1,
wherein the aforesaid connection means involve:
a first transmission shaft rotatably mounted on a fixed structure, this shaft comprising at least one portion appearing as a cylindrical sleeve, the inner bore of which comprises a first sealing surface followed by a first threaded portion;
a second transmission shaft, of cylindrical shape, which engages into the cylindrical sleeve of the first transmission shaft by delimiting with the latter an annular space, closed on one side by a bottom, this second transmission shaft successively comprising a second sealing surface and a second threaded portion;
an annular part acting as an axially mobile piston in said annular space, and having a cylindrical outer face successively comprising a third sealing surface capable of sealably sliding on the aforesaid first sealing surface and a third threaded portion having helicoidal ramps sliding in the helicoidal ramps of the aforesaid first threaded portion, and an inner face successively comprising a fourth sealing surface capable of sealably sliding on the aforesaid second sealing surface and a fourth threaded portion having helicoidal ramps sliding in the helicoidal ramps of the aforesaid second threaded portion;
a circuit for admitting pressurized fluid allowing the axial displacement of the aforesaid piston under the effect of this fluid in two working chambers delimited by the aforesaid transmission shafts and the aforesaid piston via rotating gaskets.

6. The vibrator according to claim 1,
wherein the aforesaid connection means comprise a hydraulic rotary actuator with vanes or an electric rotary actuator.

7. The vibrator according to claim 2,
wherein the aforesaid bearing formed in said first sidewall of the casing of the vibrator, comprises a rolling bearing with axial stops with which a reduced axial play may be obtained.

8. The vibrator according to claim 3,
wherein the aforesaid bearing formed in said second sidewall of the casing of the vibrator, consists of a rolling bearing with axial stops with which reduced axial play may be obtained.

9. The vibrator according to claim 1,
wherein the aforesaid first tubular drive shaft comprises a solid cylindrical portion slidably mounted in a hollow cylindrical portion of the aforesaid tubular transmission part, in the vicinity of the first cog, and interdependent in rotation with the latter by coupling.
